(19) United States
(12) Patent Application Publication
(10) Pub. No.: US 2009/0107632 A1
(43) Pub. Date: Apr. 30, 2009

(54) ADHESIVE COMPOSITIONS FOR HIGH TEMPERATURE SENSORS AND METHODS OF MAKING THE SAME

(75) Inventors: Qiwei Lu, Schenectady, NY (US); Robert James Perry, Niskayuna, NY (US); Michael Joseph O'Brien, Clifton Park, NY (US); Ying Fan, Niskayuna, NY (US); James Norman Barshinger, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/927,755

(22) Filed: Oct. 30, 2007

(51) Int. Cl. C09J 163/10

(52) U.S. Cl. 156/330; 525/523

(57) ABSTRACT

An adhesive composition is provided which effectively bonds a sensor to a surface having a temperature up to approximately 250° C. The adhesive composition comprises an epoxy resin and a latent cationic cure catalyst effective to cure the epoxy resin. The invention also provides a method of preparing an adhesive composition comprising blending an epoxy resin and a latent cationic cure catalyst effective to cure the epoxy resin, wherein the composition is capable of effectively bonding a sensor to a surface having a temperature up to approximately 250° C. The invention further provides a method of bonding a sensor to a surface comprising the steps of applying an adhesive composition to a first surface of the sensor or to a surface area of an object to be monitored, the adhesive composition comprising an epoxy compound and a latent cationic cure catalyst effective to cure the epoxy resin. The first surface of the sensor is contacted with the surface area of the object whereby the adhesive composition is located therebetween, and wherein the composition effectively bonds the sensor to the object surface at a temperature up to approximately 250° C.

### TECHNICAL FIELD

The invention includes embodiments that relate to a curable adhesive composition for use with high temperature sensors.

### BACKGROUND

Corrosion monitoring using ultrasonic nondestructive evaluation is a well-known plant management tool in the oil and gas industry. The current inspection paradigm involves periodic inspection of plant assets at predetermined TMLs (thickness measurement locations) using a handheld ultrasonic thickness gauge. A limitation of this solution is that a majority of the inspection cost involves gaining access to the TML by erecting scaffolding, stripping insulation, etc.

A newer system for ultrasonic thickness measurement is to permanently install ultrasonic sensors and instrumentation at the TMLs. Thus, it is only necessary to access the structure at the time of installation of the sensors. Once the sensors are installed, thickness measurements can be collected remotely at the desired inspection intervals.

Adhesive technology has a critical need for a more permanent installation of ultrasonic sensors. Adhesives perform two functions. Adhesives are used to physically attach the sensor to the plant asset at the TML, and adhesives are needed to transmit ultrasonic energy through the adhesive layer. Furthermore, the adhesives must perform these functions for a long duration of time, and in the harsh environments present in the oil and gas industry, including temperatures in the range of 125° C. to 250° C. or higher.

### BRIEF DESCRIPTION

The above-described problems are alleviated by an adhesive technology that effectively meets the requirements for permanently installed high temperature sensors. In one embodiment, the invention provides an adhesive composition comprising an epoxy resin; and a latent cationic cure catalyst effective to cure the epoxy resin; wherein the composition is capable of effectively bonding a sensor to a surface having a temperature up to approximately 250° C.

In one embodiment, the invention provides a method of preparing an adhesive composition comprising blending an epoxy resin and a latent cationic cure catalyst effective to cure the epoxy resin; wherein the composition is capable of effectively bonding a sensor to a surface having a temperature up to approximately 250° C.

In yet another embodiment, the invention provides a method of bonding a sensor to a surface comprising the steps of applying an adhesive composition to a first surface of the sensor or to a surface area of an object to be monitored, the adhesive composition comprising an epoxy compound; and a latent cationic cure catalyst effective to cure the epoxy resin; and contacting the first surface of the sensor to the surface area of the object, whereby the adhesive composition is located therebetween; wherein the composition effectively bonds the sensor to the object surface at a temperature up to approximately 250° C.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a graph of storage modulus as a function of temperature for CCE2 vs. CCE4.

FIG. 2 is a graph of TGA profiles of epoxy thermosets.

FIG. 3 is a graph of storage modulus as a function of temperature for a cationic cure epoxy (CCE2) with a phenyl silicone of various loadings.

FIG. 4 is a graph of TGA profiles of a cationic cure epoxy (CCE2) with a phenyl silicone of various loadings.

### DETAILED DESCRIPTION

One embodiment of the invention is an adhesive composition for use in bonding high temperature sensors to the surface of objects to be monitored. The adhesive composition comprises an epoxy resin and a latent cationic cure catalyst effective to cure the epoxy resin. The adhesive composition provides superior mechanical integrity, strong adhesion, high toughness and excellent thermal stability.

Suitable classes of epoxy resins for use in the adhesive composition include, for example, aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins (e.g. RSS1407LC from Yuka Shell), naphthalene epoxy resins (e.g., EPICLON® EXA-4700 from Dainippon Ink and Chemicals and NC-7300L from Nippon Kayaku), divinylbenzene dioxide, 2-glycidylphenylglycidyl ether, dicyclopentadiene-type (DCPD-type) epoxy resins (e.g. EPICLON® HP-7200 from Dainippon Ink and Chemicals), multi aromatic resin type (MAR-type) epoxy resins (e.g. NC-3000H from Nippon Kayaku), triphenolalkane, aralkyl (e.g. EPPN-502H from Nippon Kayaku), biphenylaralkyl and the like, and combinations thereof. All of these classes of epoxy resins are known in the art and are both widely commercially available and can be prepared by known methods. Preferably, the epoxy resin is an aralkyl and biphenyl containing epoxy resin. In addition, specific suitable epoxy resins are described, for example, in U.S. Pat. Nos. 4,882,201 to Crivello et al., 4,920,164 to Sasaki et al., 5,015,675 to Walles et al., 5,290,883 to Hosokawa et al., 6,333,064 to Gan, 6,518,362 to Clough et al, 6,632,892 to Rubinsztajn et al., 6,800,373 to Gorczyca, 6,878,632 to Yeager et al.; U.S. Patent Application Publication No. 2004/0166241 to Gallo et al., and WO 03/072628 A1 to Ikezawa et al.

In one embodiment, the epoxy resin is a solid that has a softening point of about 50° C. to about 120° C. Softening points may be determined according to ASTM E28-99 (2004). While it is possible to use epoxy resins with softening points below 50° C., the amounts of such resins should be low enough so as not to interfere with the desired friability of the curable composition as a whole.

The adhesive composition may comprise from about 50 weight percent to about 99.99 weight percent of the epoxy resin. Preferably, the adhesive composition comprises from about 80 weight percent to about 99 weight percent of the epoxy resin.

The adhesive composition comprises an amount of a latent cationic cure catalyst effective to cure the epoxy resin. A latent cationic cure catalyst is a compound capable of thermally generating a cationic cure catalyst, which in turn is capable of catalyzing epoxy homopolymerization. Suitable latent cationic cure catalysts include, for example, diaryliodonium salts, phosphonic acid esters, sulfonic acid esters, certain carboxylic acid esters, phosphonic ylides, benzylsulfonium salts, benzylpyridinium salts, benzylammonium slats, isoxazolium salts such as Woodward's reagent and Woodward's reagent K, and combinations thereof.

In one embodiment, the latent cationic cure catalyst comprises a diaryliodonium salt having the structure:

[(R3)(R4)I]+X−

wherein R3 and R4 are each independently a C6-C14 monovalent aromatic hydrocarbon radical, optionally substituted with from 1 to 4 monovalent radicals selected from C1-C20 alkyl, C1-C20 alkoxy, nitro, chloro, and like radicals which are substantially inert under encapsulation conditions; and wherein X— is an anion, preferably a weakly basic anion. Suitable diaryliodonium salts are described, for example, in U.S. Pat. Nos. 4,623,558 to Lin, 4,882,201 to Crivello et al., and 5,064,882 to Walles et al. In one embodiment, the anion X— is an MQd-anion, wherein M is a metal or metalloid, each occurrence of Q is independently halogen or perhalogenated phenyl, and d is an integer of 4 to 6. Suitable metals or metalloids, M, include metals such as Fe, Sn, Bi, Al, Ga, In, Ti, Zr, Sc, V, Cr, Mn, Cs; rare earth elements such as the lanthanides, for example, Cd, Pr, Nd, and the like, actinides, such as Th, Pa, U, Np, and the like; and metalloids such as B, P, As, Sb, and the like. In one embodiment, M is B, P, As, Sb or Ga. Representative MQd-anions include, for example, BF4—, B(C6C15)4—, PF6—, AsF6—, SbF6—, FeCl4—, SnC16—, SbC16—, BiC15—, and the like.

In another embodiment, the latent cationic cure catalyst comprises a diaryliodonium salt having the structure:

[(R³)(R⁴)I]⁺SbF₆⁻

wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro, and like radicals which are substantially inert under encapsulation conditions. An exemplary latent cationic cure catalyst is 4-octyloxyphenyl phenyl iodonium hexafluoroantimonate.

The adhesive composition comprises the latent cationic cure catalyst in an amount effective to cure the epoxy resin. The precise amount will depend on the type and amount of epoxy resin, the type of latent cationic cure catalyst, and the presence of other composition components that may accelerate or inhibit curing. Generally, the adhesive composition will comprise approximately 0.01 weight percent to approximately 5 weight percent of the latent cationic cure catalyst. Preferably, the adhesive composition will comprise approximately 0.1 weight percent to approximately 2 weight percent of the latent cationic cure catalyst.

The adhesive composition is capable of undergoing “snap cure”, a process by which the composition hardens at a pre-determined temperature within from seconds to minutes. While not wishing to be bound by any particular theory of operation, it is believed that the adhesive compositions cure by cationic, ring-opening, chain-reaction polymerization. The latent cationic cure catalyst decomposes on heating during the curing step to produce a strong Bronsted acid, which initiates ring-opening polymerization. The curing reaction thus forms ether linkages, rather than beta-hydroxy ether linkages, resulting in reduced hydrophilicity (and therefore reduced water absorption) in the cured state.

If the adhesive composition is cured at temperatures below approximately 200° C., the adhesive composition may, optionally, further comprise an effective amount of a curing co-catalyst. Suitable curing co-catalysts include, for example, free-radical generating aromatic compounds (e.g., benzopinacole), copper (II) salts of aliphatic carboxylic acids (e.g., copper (II) stearate), copper (II) salts of aromatic carboxylic acids (e.g., copper (II) benzoate, copper (II) naphthenate, and copper (II) salicylate), copper (II) acetylacetonate, peroxy compounds (e.g., t-butyl peroxybenzoate, 2,5-bis-t-butylperoxy-2,5-dimethyl-3-hexyne, and other peroxy compounds as described, for example, in U.S. Pat. No. 6,627,704 to Yeager et al.), and the like, and combinations thereof. In one embodiment, the curing co-catalyst comprises benzopinacole. In another embodiment, the curing co-catalyst comprises copper (II) acetylacetonate. A suitable concentration of curing co-catalyst will depend on the type of co-catalyst, the type and amount of epoxy resin, and the type and amount of latent cationic cure catalyst, among other factors, but it is generally about 0.01 to about 20 weight percent of the adhesive composition.

The adhesive composition may, optionally, further comprise a rubbery modifier selected from polybutadienes, hydrogenated polybutadienes, polyisoprenes, hydrogenated polyisoprenes, butadiene-styrene copolymers, hydrogenated butadiene-styrene copolymers, butadiene-acrylonitrile copolymers, hydrogenated butadiene-acrylonitrile copolymers, polydimethylsiloxanes, poly (dimethysiloxane-co-diphenylsiloxane)s, polydiphenylsiloxanes, poly(methylphenyl)siloxanes and combinations thereof; wherein the rubbery modifier comprises at least one functional group selected from hydroxy, hydrocarbyloxy, vinyl ether, carboxylic acid, anhydride, and glycidyl. Suitable rubbery modifiers include, for example, hydroxy-terminated polybutadienes, carboxy-terminated polybutadienes, maleic anhydride-functionalized (“maleinized”) polybutadienes, epoxy-terminated polybutadienes, hydroxy-terminated hydrogenated polybutadienes, carboxy-terminated hydrogenated polybutadienes, maleic anhydride-functionalized hydrogenated polybutadienes, epoxy-terminated hydrogenated polybutadienes, hydroxy-terminated styrene-butadiene copolymers (including, random, block, and graft copolymers), carboxy-terminated styrene-butadiene copolymers (including, random, block, and graft copolymers), maleic anhydride functionalized styrene-butadiene copolymers (including, random, block, and graft copolymers), epoxy-terminated styrene-butadiene copolymers (including, random, block, and graft copolymers), butadiene-acrylonitrile copolymers, hydrogenated butadiene-acrylonitrile copolymers, hydroxy-terminated (i.e., silanol-terminated) polydimethylsiloxanes, hydrocarbyloxy-terminated (i.e., carbinol-terminated) polydimethylsiloxanes, carboxy-terminated polydimethylsiloxanes, anhydride-terminated polydimethylsiloxanes, epoxy-terminated polydimethylsiloxanes, hydroxy-terminated poly(dimethysiloxane-co-diphenylsiloxane)s, carboxy-terminated poly(dimethysiloxane-co-diphenylsiloxane)s, anhydride-terminated poly(dimethysiloxane-co-diphenylsiloxane)s, epoxy-terminated poly(dimethysiloxane-co-diphenylsiloxane)s, hydroxy-terminated (i.e., silanol-terminated) polydiphenylsiloxanes, hydrocarbyloxy-terminated (i.e., carbinol-terminated) polydiphenylsiloxanes, carboxy-terminated polydiphenylsiloxanes, anhydride-terminated polydiphenylsiloxanes, hydroxy-terminated poly(methylphenyl)siloxanes, hydrocarbyloxy-terminated poly(methylphenyl)siloxanes, epoxy-terminated poly(methylphenyl)siloxanes, carboxy-terminated poly(methylphenyl)siloxanes, anhydride-terminated poly(methylphenyl)siloxanes and the like, and combinations thereof. These rubbery modifiers and methods for their preparation are known in the art, and most are commercially available. A suitable concentration of rubbery modifier will depend on the type of flame retardant, the type and amount of epoxy resin, the type and amount of polyphenylene ether, and the filler loading, among other factors, but it is generally about 1 to about 30 weight percent of the adhesive composition. Rubbery modifiers may be in the form of finely dispersed particles or reactive liquids.

The adhesive composition may, optionally, further comprise one or more additives known in the art. Such additives include, for example, phenolic hardeners, anhydride hardeners, thermal stabilizers, adhesion promoters, chain transfer agents, inorganic fillers and the like, and combinations thereof. Those skilled in the art can select suitable additives and amounts. When phenolic hardeners and/or anhydride hardeners are present, they are used in an amount such that the primary curing mechanism is epoxy homopolymerization induced by the cure catalyst.

The adhesive composition effectively bonds sensors at elevated temperatures, as well as ambient and sub-ambient temperatures. Specifically, the adhesive composition is capable of effectively bonding or securing a sensor to the surface of an object to be monitored, wherein the surface has a temperature up to approximately 250° C. Preferably the object surface has a temperature between approximately 125° C. and approximately 250° C., and more preferably between approximately 125° C. and approximately 200° C. The adhesive composition is capable of effectively bonding or securing a sensor to an object surface at temperatures up to about 250° C. for a period of at least five years without appreciable loss of mechanical and acoustic properties of the composition.

As the adhesive composition is defined as comprising multiple components, it will be understood that each component is chemically distinct, particularly in the instance that a single chemical compound may satisfy the definition of more than one component.

The invention includes methods of preparing the adhesive composition. One such embodiment is a method of preparing an adhesive composition comprising blending an epoxy resin and a latent cationic cure catalyst effective to cure the epoxy resin, wherein the composition is capable of effectively bonding a sensor to a surface having a temperature up to approximately 250° C. In one embodiment, the epoxy resin and the latent cationic cure catalyst are blended by melt mixing the substances together at a temperature of about 90° C. to about 115° C.

In the methods described herein, the object surface preferably has a temperature between approximately 125° C. and approximately 250° C., and more preferably has a temperature between approximately 125° C. and approximately 200° C.

Another embodiment is a method of preparing an adhesive composition comprising dry blending an epoxy resin and a latent cationic cure catalyst effective to cure the epoxy resin to form a first blend. Preferably, the first blend is then melt mixed at a temperature of about 90° C. to about 115° C. to form a second blend. The second blend is cooled to a temperature between approximately 0° C. and approximately 40° C., and is then ground to form the adhesive composition.

The invention also includes methods of bonding a sensor to the surface of an object to be monitored. The adhesive composition is applied to a surface of the sensor or to a surface area of an object to be monitored. Any method known to those having skill in the art may be used to apply the adhesive composition including, but not limited to spraying, painting, roller coating or doctor blade coating. The adhesive composition may be applied as a liquid or as a dry adhesive mixture.

The adhesive composition may be melted at a temperature below the catalyst activation temperature prior to, during or after application of the adhesive to the sensor or object surface. For example, the dry adhesive mixture may be heated beyond its softening point to form a melted adhesive composition which is then applied. In addition, a melted adhesive composition may be applied to the sensor or object surface area and allowed to cool to form a solid adhesive film.

The adhesive composition may be applied to form an adhesive layer on the surface of the sensor or the surface of the object to be monitored. Preferably the adhesive layer has a thickness between approximately 10 mil and approximately 2 mm. More preferably, the adhesive layer has a thickness between approximately 5 mil and approximately 1 mm.

Following application of the adhesive composition, the surface of the sensor is contacted with the surface of the object, whereby the adhesive composition is located therebetween. If desired, the object surface may be mechanically, chemically, or electrochemically treated to form a strong bonding surface. Common methods of treating the surface include, for example, grit blasting, silane treatment, silicon sputtering, anodization with sodium hydroxide or chromic acid, and Corona discharge.

The adhesive composition is then allowed to cure to bond or secure the sensor to the object surface. For example, after the adhesive composition is applied to the surface of the sensor, the composition may be melt flowed to form a thin adhesive layer, and snap cured within a minute thereby bonding the sensor to the surface to be monitored.

Any method known to those having skill in the art may be used to cure the adhesive composition. For example, the surface temperature of the object or substrate to be bonded may be of sufficiently high temperature to effect cure. Alternatively, an external heating device, such as a heat gun or induction heating system, may be used to increase the temperature of the object surface and the adhesive composition to effect cure.

The adhesive composition may be cured at a temperature between about 100° C. and 250° C. More particularly, the adhesive composition may be cured at a temperature between about 125° C. and about 200° C.

The adhesive composition is particularly useful in bonding sensors to test objects such as pipes, vessels, and metal structures, which are the basic structures found in oil and gas refinery, power plant and aerospace industry. The sensors monitor the corrosion rates of the object wall, which may operate at temperatures approaching 250° C. The adhesive composition may be used to bond various types of sensors, including but not limited to acoustic sensors, vibration sensors and gas sensors.

The invention is further illustrated by the following non-limiting examples.

### EXAMPLE 1

The screening of materials was accomplished by pre-heating the delay line surrogate (a cylinder of titanium (½″×½″) or a cube of Macor ceramic (½″)) above the softening point of the epoxy adhesive composition then allowing the composition to harden. The steel coupon (1″×1″× 3/16″) was heated to the cure temperature. The delay line with the hardened adhesive composition was applied to the coupon surface and held in place by an approximately 10 gram weight until cure was complete.

After the coupon was well attached and brought to ambient temperature, a drop of glycerin was applied to the top surface of the delay line and acoustic readings were taken using an ultrasound pulse/echo technique.

TABLE 1
Epoxy Formulations

| Function | Type | Chemical Name | Physical Properties | Source & Grade | CCE1 | CCE2 | CCE3 | CCE4 | CCE5 |
|---|---|---|---|---|---|---|---|---|---|
| Epoxy | Naphthalene | (2-glycidyloxynaphthyl)[2,7- | Epoxy Equiv | Epiclon | 100 | | | | |
| Monomer | | bis(glycidyloxy)naphthyl]methane | Wt = 166; | EXA-4700, | | | | | |
| | | (Cas No. 146794-56-1) | s.p. = 89° C. | DaiNippon Ink | | | | | |
| | | | | & Chemical | | | | | |
| Epoxy | MAR | 4-methylenebiphenyl-4′-co- | Epoxy Equiv | NC-3000-H, | | 100 | | | |
| Monomer | | (glycidoxyphenyl) methylene | Wt = 287; | Nippon Kayaku | | | | | |
| | | oligomer | s.p. = 69° C. | | | | | | |
| Epoxy | MAR/BP | mixture of 4- | Epoxy Equiv | CER-3000-L, | | | 100 | | |
| Monomer | | methylenebiphenyl-4′-co- | Wt = 236; | Nippon Kayaku | | | | | |
| | | (glycidoxyphenyl) methylene | s.p. = 94° C. | | | | | | |
| | | oligomer and 4,4′- | | | | | | | |
| | | diglycidoxybiphenyl | | | | | | | |
| Epoxy | Aralkyl | diglycidoxyether | Epoxy Equiv | EPPN-502H, | | | | 100 | |
| Monomer | | diphenylmethane oligomer | Wt = 170; | Nippon Kayaku | | | | | |
| | | | s.p. = 67° C. | | | | | | |
| Epoxy | Naphthalene | glycidoxynaphthyl methylene- | Epoxy Equiv | NC-7300L, | | | | | 100 |
| Monomer | | co-glycidoxytolyl methylene | Wt = 213; | Nippon Kayaku | | | | | |
| | | oligomer | s.p. = 62° C. | | | | | | |
| Catalyst | OPPI | Octyloxyphenylphenyliodonium | | UV9392C, | 1.00 | 1.00 | 1.00 | 1.00 | 1.00 |
| | | Hexafluoroantimonate | | Hampford | | | | | |
| | | (Cas. No. 121239-75-6) | | Research | | | | | |

The thermoset materials listed in Table 1 are highly aromatic epoxy compounds and are mainly used in electronic applications due to their high heat resistance, low melt viscosity, high adhesiveness, low moisture absorption, flame retardancy, and low coefficient of thermal expansion, etc. The last five columns in Table 1 represent the parts by weight of the epoxy monomer and cationic cure catalyst in each cationic cure epoxy composition. In addition, these epoxy compounds are all capable of undergoing “snap cure”. This was accomplished by the use of an iodonium salt as a super acid catalyst following a mechanism of cationic ring-opening homopolymerization of epoxy groups, as depicted in Scheme 1 below.

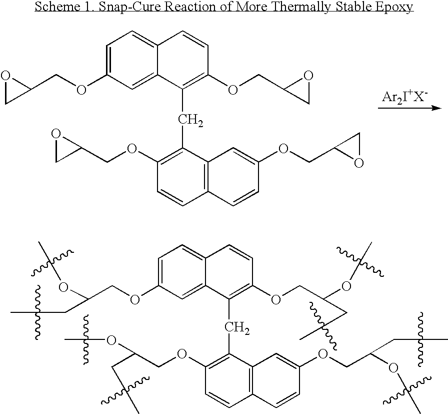

### EXAMPLE 2

### Thermal Stability

Thermogravimetric analysis (TGA) of the polymeric adhesives was undertaken to compare the thermal stability of the materials examined in Table 1 and also estimate the activation energies of thermal degradation and acceleration factors. Activation energies of a material can be calculated from the thermal decomposition curves obtained from TGA measurements.

The thermal degradation of thermoset materials was performed in a thermogravimetric analyzer (TGA7, Perkin-Elmer) under dynamic conditions between 30° C. and 900° C. at a programmed heating rate of 10° C./min or isothermal conditions at 300° C. for 48 hrs in both a nitrogen and air atmosphere with a gas flow of 20 mL/min. Other heating rates of 2, 5, 15, and 20° C./min were also employed for the dynamic mode. A sample with an average mass of approximately 6 mg was loaded.

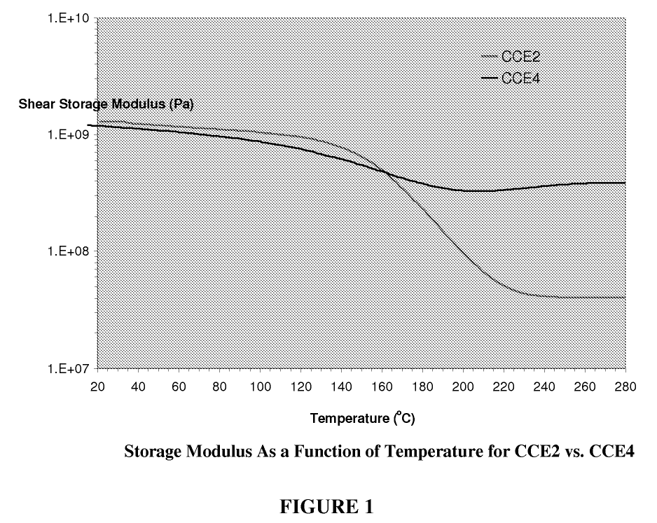

Cationic cure epoxy was thus highly preferred due to its snap cure characteristics and its formulations are simply based on a highly aromatic epoxy plus an iodonium salt as the super acid catalyst (See Table 1). Its cure temperature and time, and physical properties such as Tg, crosslink density, modulus, adhesion, etc. can also be tuned via different chemical structures of the epoxy compounds. For example, CCE4 showed a rubber plateau modulus about an order of magnitude higher than CCE2 as shown in FIG. 1 due to a higher crosslink density, very consistent with its lower epoxy equivalent molecular weight.

TABLE 2
TGA Results and Calculated Activation Energies of Thermosets

| | | Cationic Cure | Cationic Cure | Cationic Cure | Cationic Cure | Cationic Cure |
|---|---|---|---|---|---|---|
| | Cotronics | Bis-Naphthalene | Biphenyl | Biphenyl | Trisphenyl methane | Naphthalene |
| | 4460 ® | (CCE1) | (CCE2) | (CCE3) | (CCE4) | (CCE5) |
| Tₜ (° C.) | 375 | 389 | 404 | 382 | 392 | 388 |
| Eₐ (kJ/mol) | 99 | 105 | 104 | 48 | 138 | 97 |
| Acceleration | 11 | 13 | 12 | 3 | 28 | 11 |
| from 200° C. to | | | | | | |
| 250° C. (X) | | | | | | |
| Acceleration | 7 | 8 | 8 | 3 | 16 | 7 |
| from 250° C. to | | | | | | |
| 300° C. (X) | | | | | | |

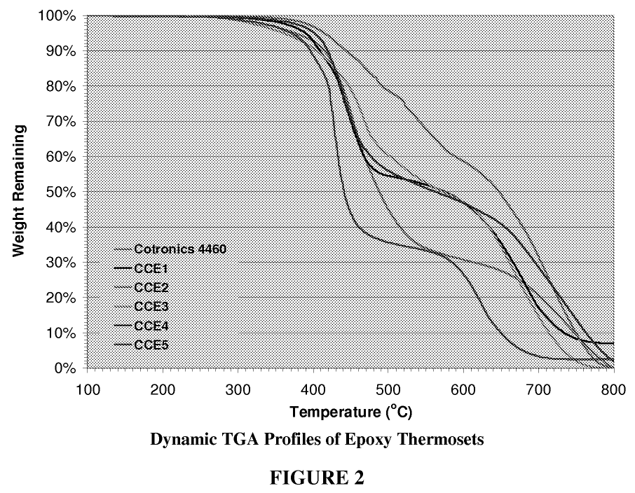

The thermal stability of various aromatic epoxy compounds was ranked in a decreasing order as follows: CCE2>CCE4>CCE1>Cotronics 4460>CCE5>CCE3 (see FIG. 2). CCE2 is based on such a highly aromatic biphenyl type MAR resin that it is inherently flame retardant. All the highly aromatic epoxy resins are glassy or crystalline solid at room temperature, which enables easy processing and application.

### EXAMPLE 3

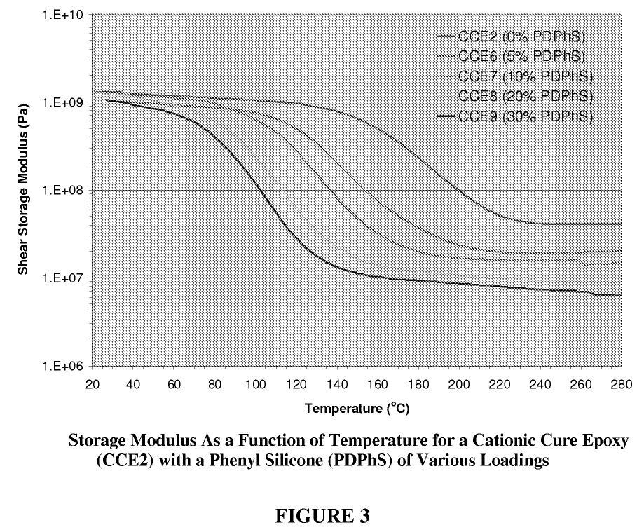

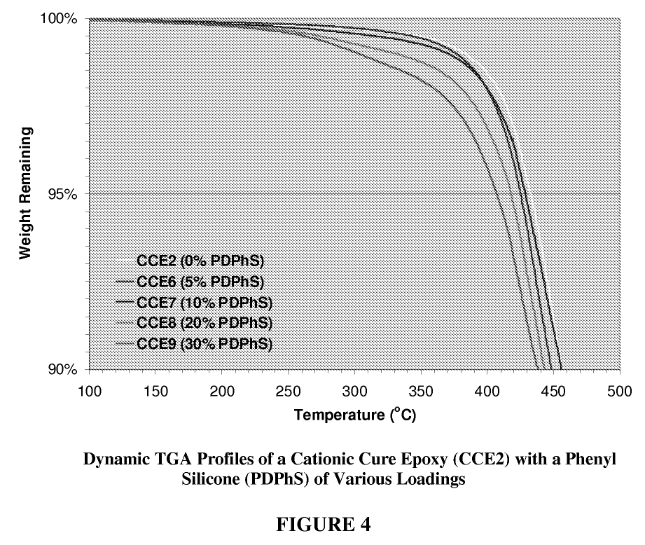

The accelerated thermal aging indicated the cationic cure epoxy had much better heat performance than Cotronics®. Although the new epoxy adhered much longer, cracks were observed in the cured parts around the edge of the delay line. To address this crack issue, common solutions include lowering the stress (by either reducing the x-link density/rubber plateau modulus or lowering the coefficient of thermal expansion) and improving fracture toughness/crack resistance. The first stress reliever that was tried was a phenyl silicone resin (silanol terminated polydiphenylsiloxane, PDS-9931, Gelest) as shown in Table 4 below. The last four columns in Table 4 represent the parts by weight of the epoxy monomer, cationic cure catalyst, and stress relief agent in each cationic cure epoxy composition. Both Tg and rubber plateau modulus were reduced with increasing loading of the phenyl silicone resin, as shown in FIG. 3. Besides increasing the miscibility of the phenyl silicone with the epoxy component, the silanol on the chain ends can also act as a chain transfer group to lower the crosslink density. Meanwhile, little affect on thermal stability was observed at low phenyl silicone loading, as shown in FIG. 4.

TABLE 4

| Function | Name | Chemical Name | Physical Properties | Source & Grade | CCE6 | CCE7 | CCE8 | CCE9 |
|---|---|---|---|---|---|---|---|---|
| Epoxy | MAR | 4-methylenebiphenyl-4′-co- | Epoxy Equiv | NC-3000-H, | 95 | 90 | 80 | 70 |
| Monomer | | (glycidoxyphenyl) methylene | Wt = 287; | Nippon Kayaku | | | | |
| | | oligomer | s.p. = 69° C. | | | | | |
| Catalyst | OPPI | Octyloxyphenylphenyliodonium | | UV9392C, | 0.95 | 0.90 | 0.80 | 0.70 |
| | | Hexafluoroantimonate | | Hampford Research | | | | |
| | | (Cas. No. 121239-75-6) | | | | | | |
| Stress Relief | Phenyl | Silanol Terminated | s.p. > 55° C., | PDS-9931, Gelest | 5 | 10 | 20 | 30 |
| Agent | Silicone | Polydiphenylsiloxane (Cas. | b.p. > 205° C.; | | | | | |
| | | No. 63148-59-4) | MW = 900~1400 | | | | | |

### EXAMPLE 4

### Representative Siloxane/Epoxy Composition

CCE7—Epoxy NC-3000H (9.0 g) and PDS-9931 (1.0 g of silanol endcapped polydiphenylsiloxane, Gelest, MW 900-1000) were ground together. An aliquot (5.76 g) of the mixture was combined with 52 mg (1 wt % of active epoxy component) of OPPI (octyloxyphenylphenyl iodonium hexafluoroantimonate), reground to a fine powder and used as the siloxane modified epoxy adhesive.

As shown below in Table 5, the addition of small amounts of silicone stress relievers improved the lifetime of the bonded sensors.

TABLE 5
High Temperature Soaking Test for Modified Cationic Cure Epoxy

| | | Temperature | |
|---|---|---|---|
| Delayline | Adhesive | (° C.) | Life (day) |
| Macor | CCE7 | 288 | 31 |
| Macor | CCE6 | 288 | 20 |
| Macor | CCE8 | 288 | 6 |
| Macor | Cotronics 4460 | 288 | 1 |
| Ti | CCE6 | 288 | 11 |
| Ti | CCE8 | 288 | 3 |
| Ti | Cotronics 4460 | 288 | 1 |

All cited patents, patent applications, and other references are incorporated herein by reference in their entirety.

All ranges disclosed herein are inclusive of the endpoints, and the endpoints are combinable with each other.

It is to be noted that the terms “first,” “second,” and the like as used herein do not denote any order, quantity, or importance, but rather are used to distinguish one element from another. The modifiers “about” and “approximately” used in connection with a quantity is inclusive of the stated value and has the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. An adhesive composition comprising:
an epoxy resin; and
a latent cationic cure catalyst effective to cure the epoxy resin;
wherein the composition is capable of effectively bonding a sensor to a surface having a temperature up to approximately 250° C.

2. The adhesive composition of claim 1, wherein the epoxy resin has a softening point of about 50° C. to about 120° C.

3. The adhesive composition of claim 1, wherein the composition is capable of effectively bonding the sensor to the surface for a period of approximately five years.

4. The adhesive composition of claim 1, wherein the adhesive composition is in the form of a layer.

5. The adhesive composition of claim 4, wherein the layer has a thickness between approximately 5 mil and approximately 2 mm.

6. The adhesive composition of claim 1, wherein the epoxy resin is selected from aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins, naphthalene epoxy resins, divinylbenzene dioxide, 2-glycidylphenylglycidyl ether, dicyclopentadiene-type epoxy resins, multi aromatic resin type epoxy resins, triphenolalkane, aralkyl, biphenylaralkyl and combinations thereof.

7. The adhesive composition of claim 6, wherein the epoxy resin comprises an aralkyl or biphenyl group.

8. The adhesive composition of claim 1, wherein the latent cationic cure catalyst is selected from diaryliodonium salts, phosphonic acid esters, sulfonic acid esters, carboxylic acid esters, phosphonic ylides, benzylsulfonium salts, benzylpyridinium salts, benzylammonium salts, isoxazolium salts, and combinations thereof.

9. The adhesive composition of claim 1, wherein the latent cationic cure catalyst comprises a diaryliodonium salt having the structure
[(R³)(R⁴)I]⁺X⁻
wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro; and wherein X⁻ is an anion.

10. The adhesive composition of claim 1, wherein the latent cationic cure catalyst comprises a diaryliodonium salt having the structure [(R³)(R⁴)I]⁺SbF₆⁻ wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro.

11. The adhesive composition of claim 1, wherein the latent cationic cure catalyst comprises 4-octyloxyphenyl phenyl iodonium hexafluoroantimonate.

12. The adhesive composition of claim 1, wherein the composition comprises between about 50 weight percent and about 99.99 weight percent of the epoxy resin.

13. The adhesive composition of claim 1, wherein the composition comprises between about 0.01 weight percent and about 5 weight percent of the latent cationic cure catalyst.

14. The adhesive composition of claim 1, further comprising a curing co-catalyst selected from free-radical generating aromatic compounds, peroxy compounds, copper (II) salts of aliphatic carboxylic acids, copper (II) salts of aromatic carboxylic acids, copper (II) acetylacetonate, and combinations thereof.

15. The adhesive composition of claim 1, further comprising a rubbery modifier selected from polybutadienes, hydrogenated polybutadienes, polyisoprenes, hydrogenated polyisoprenes, butadiene-styrene copolymers, hydrogenated butadiene-styrene copolymers, butadiene-acrylonitrile copolymers, hydrogenated butadiene-acrylonitrile copolymers, polydimethylsiloxanes, poly(dimethysiloxane-co-diphenylsiloxane)s, and combinations thereof; wherein the rubbery modifier comprises at least one functional group selected from hydroxy, hydrocarbyloxy, vinyl ether, carboxylic acid, anhydride, and glycidyl.

16. The adhesive composition of claim 1, further comprising an additive selected from phenolic hardeners, anhydride hardeners, thermal stabilizers, adhesion promoters, and combinations thereof.

17. A method of preparing an adhesive composition comprising:
blending an epoxy resin and a latent cationic cure catalyst effective to cure the epoxy resin;
wherein the composition is capable of effectively bonding a sensor to a surface having a temperature up to approximately 250° C.

18. The method of claim 17, wherein blending the epoxy resin and latent cationic cure catalyst comprises:
melt mixing the epoxy resin and cationic cure catalyst at a temperature of about 90° C. to about 115° C.

19. The method of claim 17, wherein the epoxy resin and the latent cationic cure catalyst are dry blended to form a first blend; and the method further comprises:
melt mixing the first blend at a temperature of about 90° C. to about 115° C. to form a second blend;
cooling the second blend; and
grinding the cooled second blend to form the adhesive composition.

20. A method of bonding a sensor to a surface comprising the steps of:
applying an adhesive composition to a first surface of the sensor or to a surface area of an object to be monitored, the adhesive composition comprising:
an epoxy resin;
and a latent cationic cure catalyst effective to cure the epoxy resin; and
contacting the first surface of the sensor to the surface area of the object, whereby the adhesive composition is located therebetween;
wherein the composition effectively bonds the sensor to the object surface at a temperature up to approximately 250° C.

21. The method of claim 20, wherein the adhesive composition is applied by spraying, painting, roller coating or doctor blade coating.

22. The method of claim 20, wherein the adhesive composition is applied to form a layer on the surface of the sensor or on the object surface area.

23. The method of claim 20, further comprising:
melting the adhesive composition prior to, during or after application of the adhesive composition to the sensor or object surface.

24. The method of claim 20, further comprising:
curing the adhesive composition to bond the sensor to the object surface.

25. The method of claim 24, wherein the adhesive composition is cured at a temperature between about 100° C. and 250° C.
